(19) United States
(12) Patent Application Publication
(10) Pub. No.: US 2012/0052808 A1
(43) Pub. Date: Mar. 1, 2012

(54) AUDIBLE AND VISIBLE REMOTE CELL PHONE ALERT AND VISIBLE REMOTE MISSED CALL ALERT

(75) Inventor: Kevin McMeans, Home, PA (US)

(73) Assignee: ZORKOS., Home, PA (US)

(21) Appl. No.: 13/039,681

(22) Filed: Mar. 3, 2011

Related U.S. Application Data
(60) Provisional application No. 61/310,097, filed on Mar. 3, 2010.

(51) Int. Cl. H04B 7/00

(52) U.S. Cl. 455/41.3; 455/567

(57) ABSTRACT

A remote cell phone alert and missed call alert system is configured to identify when a call is or has been received on a designated cell phone. The system includes a housing; a wireless interface configured to be coupled wirelessly to at least one cell phone and configured to receive a signal when a call is received by one associated cell phone; at least one visible light on the housing visible from at least 300 feet coupled to the wireless interface and configured to be illuminated in a designated pattern following when a call has been received by one associated cell phone; an audible alert on the housing coupled to the wireless interface and configured to indicate at least when a call is being received; and a reset mechanism configured to turn off each visible light and the audible alert whereby the system is reset for another call.

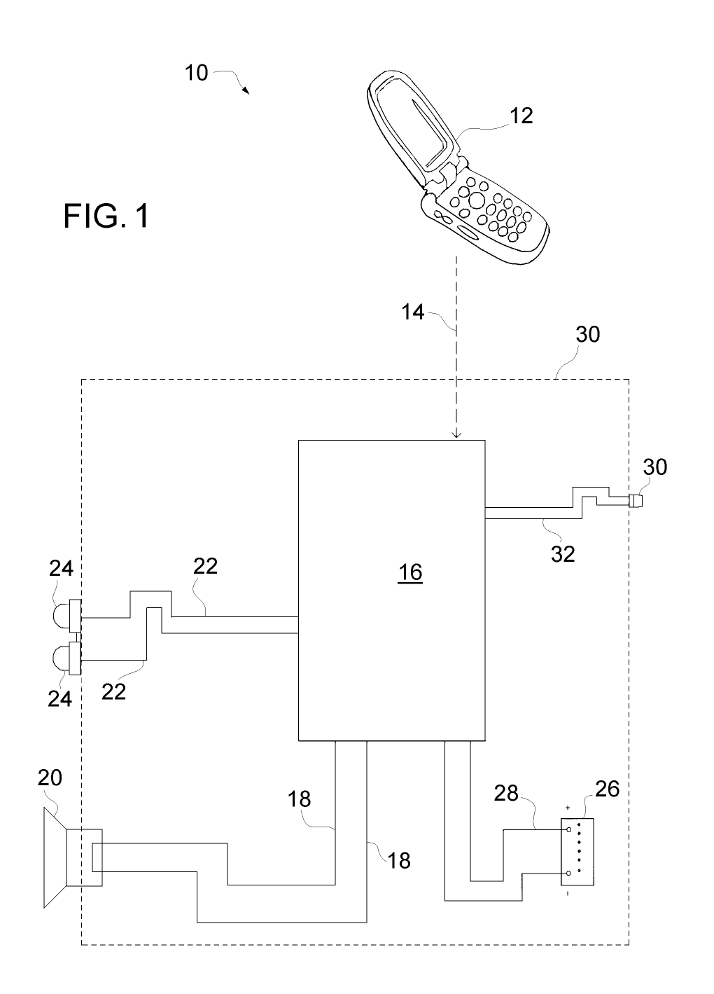

The present invention claims priority of U.S. Provisional Patent Application Ser. No. 61/310,097 entitled “Remote Cell Phone Call Identifying Ringer and Flasher” filed Mar. 3, 2010.

### BACKGROUND OF THE INVENTION

1. Field of the Invention

The present invention relates to remote ringers for cell phones and more particularly, the present invention is directed to a Bluetooth cell phone ringer system with visible remote missed call alert.

2. Background Information

Mobile phone use has grown at an incredible pace. A United Nations report issued March 2009 suggesting that roughly half of the world's population was utilizing mobile phones. The report of International Telecommunications Union (ITU), an agency of the UN, indicated that by the end of 2008 there were an estimated 4,100,000,000 mobile subscriptions, up from roughly 1,000,000,000 in 2002. It is clear that cells phone usage is a primary method of communication for many people.

Calls “not getting through” and lost calls are a constant area of concern in the cell phone industry, and the industry is working diligently to minimize lost calls and increase coverage areas for their respective networks. However, there are situations where the recipient of the call does not know a call has come in, the call is unanswered. Voice mail allows the caller in such a situation to leave a message, but there is still a breakdown in the communication chain as the recipient of the call does not even realize he has missed a call until he checks his phone.

The failure to be notified of a call (or text message or other telephonic communication) till one checks the cell phone is exacerbated in selected harsher environments and where the cell phone is left behind and for many handicapped individuals. For example, people who work with or in or service heavy equipment out in the field complain they cannot hear the cell phone ring, or feel it vibrate, in their work environment and are thus constantly are missing important calls. There are a number of workers that work in environments that are not conducive to even carrying cell phones, and such phones are left at a remote location, typically in the person's vehicle.

There is a need to assist people in identifying when a call has been received on a cell phone, and in particular in being able to identify to the user from a distance when a call has been received on a cell phone. There is a need to provide a device that easily identifies incoming cell phone calls in a cost effective manner.

It is an object of the present invention to address the deficiencies of the prior art discussed above and to do so in an efficient, cost effective manner.

### SUMMARY OF THE INVENTION

The various embodiments and examples of the present invention as presented herein are understood to be illustrative of the present invention and not restrictive thereof and are non-limiting with respect to the scope of the invention.

According to one non-limiting embodiment of the present invention, a remote missed call alert system is provided including a housing; a wireless interface within the housing and configured to be coupled wirelessly to at least one cell phone and configured to receive a signal at least when a call is received by one associated cell phone; at least one visible light on the housing which is visible from at least 300 feet coupled to the wireless interface and configured to be illuminated in a designated pattern following the wireless interface indicating that a call has been received by one associated cell phone; and manual reset on the housing configured to turn off each visible light whereby the system is reset for another call.

According to one non-limiting embodiment of the present invention, a remote cell phone alert and missed call alert system is configured to identify to the user when a call is being and has been received on a designated cell phone. The system comprises a housing; a wireless interface within the housing and configured to be coupled wirelessly to at least one cell phone and configured to receive a signal at least when a call is received by one associated cell phone; at least one visible light on the housing which is visible from at least 300 feet coupled to the wireless interface and configured to be illuminated in a designated pattern following the wireless interface indicating that a call has been received by one associated cell phone; an audible alert on the housing coupled to the wireless interface and configured to indicate at least when a call is being received; and a reset mechanism configured to turn off each visible light and the audible alert whereby the system is reset for another call.

According to one non-limiting embodiment of the present invention, a remote cell phone ringer and flasher is provided to identify to the user when a call is being and has been received on a designated cell phone. This device is a ringer and flasher that are triggered by a cell phone via a bluetooth connection. This ringer will include a loud siren (rated over 100 Db at 3 ft and is audible at over 150 ft), and the device includes a bright flashing strobe (visible at over 300 ft).

The device has been designed to solve a problem such as encountered in the big equipment service field to overcome noise and ringers in the phone that are impossible to hear for workers. The device will also be particularly useful for workers that are required to leave their cell phones behind. The user of the present device can look over at his automobile, or other area he has left the device of the invention and his phone, and receive immediate visual indication that a call has come in and he should go back at the first opportunity to check the messages or return the call, etc.

These and other advantages of the present invention will be clarified in the description of the preferred embodiments taken together with the attached figures.

### BRIEF DESCRIPTION OF THE DRAWING

The FIGURE is a schematic representation of an audible and visible remote cell phone alert and visible remote missed call alert system to identify to the user when a call is being or has been received on a designated cell phone in accordance with one embodiment of the present invention.

### DESCRIPTION OF THE PREFERRED EMBODIMENTS

In summary, the present invention relates to a an audible and visible remote cell phone alert and visible remote missed call alert system 10 to identify to the user when a call is being or has been received on a designated cell phone 12.

In overview, the system 10 is remote cell phone call alert and missed call alert system configured to identify to the user when a call is being and has been received on a designated cell phone 12 comprising: a housing 30; a wireless interface 16 within the housing 30 and configured to be coupled wirelessly to at least one cell phone 12 and configured to receive a signal 14 at least when a call is received by one associated cell phone 12; at least one visible light 24 on the housing 30 which is visible from at least 300 feet and coupled (through circuitry 22) to the wireless interface 16 and configured to be illuminated in a designated pattern following the wireless interface 16 indicating that a call has been received by one associated cell phone 12; an audible alert device 20 on the housing 30 coupled through circuitry 18) to the wireless interface 16 and configured to indicate at least when a call is being received on the cell phone 12; and a reset mechanism 30 configured to turn off each visible light 24 and the audible alert 20 whereby the system 10 is reset for another call. Note that the audible alert device 20 is formed by a speaker which can be called a ringer, siren, or merely audible alert or audible alarm. Similarly the visible light 24 can be referenced as a visible alert or visible alarm or strobe light or strobe within this application.

In brief summary, this device 10 is a ringer 20 and flasher 24 that are triggered by a cell phone 12 via a bluetooth connection 16. This ringer will include a loud siren which is rated at 103 Db at 3 ft and is audible over 150 ft away (even 250 ft), and the device 10 includes a bright flashing strobe for lights 24 which is visible outdoors in daylight at over 350 feet (and over 500 feet).

A cell phone 12, or mobile phone or hand phone, is an electronic device used for mobile telecommunications (mobile telephony or more generically phone calls, text messaging or data transmission such as a video) over a cellular network of specialized base stations known as cell sites owned by a mobile network operator.

Within the meaning of the present invention any incoming signal to the cell phone 12 can be a “call”, including incoming phone calls, incoming text messages, incoming data such a videos or the like. The interface of the wireless interface 16 and/or the cell phone 12 may allow the user to distinguish between the types of incoming call and only send signal 14 for selected types of calls (where this is done on the wireless interface 16, the cell phone will generate signals for each type of call but the interface will differentiate such signals such that only those associated with the desired types of calls are the operational signal 14). For example, the device 10 may go off only for telephone calls but not for text messages or the like.

It is further possible to have the system 10 be triggered only for phone calls from selected numbers. The technology to distinguish incoming signals and even identify those from selected numbers is well known in the telephony arts, and can be incorporated into the device 10 of the present invention at the interface 16. However, there remains a need to keep the system 10 easy to use and inexpensive, such that the degree that such additional features are integrated into the interface 16 of the present invention is related to the cost and complexity of operation for such items, thus it may be preferable if such functionality is left to that available on the cell phones 12 themselves.

The cell phone interface 16 of the present invention is preferably a Bluetooth interface that can be connected to one or more user's cell phone(s) 12 that will detect when the connected cell phone 12 is receiving a call via signal 14. Bluetooth is an open wireless protocol for exchanging data over relatively short distances using short length radio waves from fixed and mobile devices, creating personal area networks (PANs). Bluetooth uses a radio technology called frequency hopping spread spectrum, which chops up the data being sent and transmits chunks of it on up to 79 frequencies. Bluetooth provides a conventional method to connect and exchange information between electronic devices, and Bluetooth specifications are developed and licensed by the Bluetooth Special Interest Group (SIG). The Bluetooth SIG consists of companies in the areas of telecommunication, computing, networking, and consumer electronics. Bluetooth is a standard and a communications protocol primarily designed for low power consumption, with a relatively short range. As the Bluetooth devices use a radio (broadcast) communications system, they do not have to be in line of sight of each other.

A mobile phone 12 that is Bluetooth enabled is able to pair with many devices, including the system 10 of the present invention. In order to ensure the broadest support of feature functionality together with legacy device support, the Open Mobile Terminal Platform (OMTP) forum has published a recommendations paper, entitled “Bluetooth Local Connectivity”.

The present device uses such a conventional Bluetooth interface 16 allowing it to be used with all Bluetooth enable phones. As Bluetooth headsets for cell phones were one of the first large implementations of Bluetooth technologies, it is essentially standard on many cell phones. The typical wireless coupling range of the device of the present invention is 150 feet, but it is envisioned that the phone 12 will be close to the device 10 of the invention and it is the user that is remote.

In the present system 10 when an incoming call is received on a cell phone 12 coupled to the present device 10 through the Bluetooth connection, the Bluetooth interface 16 will receive the signal 14 of an incoming call and the interface 16 will close a relay that will send 12 volts DC from battery 26 through circuitry 28 to i) the circuitry 18 for a loud siren ringer 20 and to ii) the circuitry 22 for lights 24 to trigger a flashing strobe light. The siren and strobe should get the attention of the person receiving the call, assuming they are in the immediate vicinity.

The relay can be set to latch until turned off by the user or work via a manual reset switch 30 on the housing coupled to the interface through circuitry 32. Alternatively the relay may only be closed as long as the interface 16 receives a signal 14 from the ringing cell phone 12 similar to conventional ringers.

It is preferred that the visible alert formed by lights 24 remain operational until reset while the audible alarm can be cut off when the call is missed and the signal 14 ceases. In this manner there is an indication of an incoming call and a distinguishable indication of a missed call. Thus if the user is in the vicinity when the call is received the siren 20 (and strobe 24) will indicate to the user to answer the call, and reset the device 10. However, if the user is not in the vicinity the strobe 24 remains active after the incoming call has ceased as a visual indication to the user that a call has been received.

As a practical example of use of the present system 10, where a field worker leaves his cell phone 12 in his automobile coupled to the present device 10 while he is out working, a quick glace over at his car can give him immediate notice of the presence of an incoming call. When such a worker is expecting an important call he need not trek back to his car unless there is a signal that a call is being or has been received. Further, the present invention in such an application will significantly reduce the time between when a call is made and when the worker gets this information.

Another important aspect of the present invention is low power siren and strobe. The strobe can be effectively made with LED lighting elements 24 to provide for long life and low power consumption. Low power requirements allow the unit to have a simple battery supply 26. A system that ties into the user's automobile power is possible but deemed detrimental as it would be undesirable for the system to drain power from the user's automobile.

As discussed above, the remote missed call alert system 10 for a cell phone(s) 12 provides at least one visible light 24 which can be formed as a strobe light. As shown it is desirable if the lights 24 are formed as a series of lights 24 in a light array provided on the housing 30. One alternative of the invention is to provide visible lights 24 of at least two distinct colors are provided. With distinct colored lights several possibilities are presented with the operation of the invention. First multiple cell phones 12 may be coupled to the system 10 wherein distinct colored lights 24 are indicative of missed calls on distinct cell phones. There are existing interfaces 16 for cell phones that accommodate multiple phones (see XLINK brand Bluetooth wireless interface products). It may be easier to have distinct circuits 22 for each distinct color of light 24. The distinct colored lights may be indicative of incoming calls from distinct telephone numbers for a cell phone 12 provided distinct signals 14 can be generated for each call number or group of numbers. Further distinct colored lights 24 may be used to be indicative of distinct telephonic inputs received on the associated cell phone, such as a telephone call or a received text or a received e-mail or video or the like. This too requires differentiation in the signal 14.

The system may be configured such that the visible light 24 is configured to provide one lighting pattern (e.g. solid non blinking pattern) for when an incoming call is being received and a second pattern (e.g., strobe) when a call has been received as was missed.

The practical or particular applications of the present invention include commercial applications such as (i) users of heavy equipment—those working in or around front loaders, back hoes, dump trucks or the like where the device can be placed in the cab of such devices for those working on the equipment or a central location for those working around the equipment; (ii) warehouse/factory floor environments where equipment drowns out conventional cell phone ringers and or where cell phones need to be left in a remote location due to the working environment; (iii) outdoor service industry—such as well inspection, other activities in which a cell phone is often left behind. Other applications of the present invention include for hearing impaired individuals. Further applications of the present invention include residential uses where the device allows homeowners to work in the back yard with the device on the back porch.

There are many alternatives to the present invention that are within the scope of the broad teachings of this invention. The goal is to provide a remote ringer and flasher for cell phone users to identify when an incoming call is being or has been received for use in areas where they may not otherwise be aware of such calls.

What is claimed is:

1. A remote cell phone ringer and flasher configured to identify to the user when a call has been received on a designated cell phone, wherein the device includes a ringer and flasher that are triggered by a cell phone via a bluetooth connection and wherein ringer will include a loud siren, and the device includes a bright flashing strobe.

2. The remote cell phone ringer and flasher according to claim 1 wherein the flashing strobe will continue to indicate that a call has been received until the remote cell phone ringer and flasher is reset.

3. The remote cell phone ringer and flasher according to claim 2 wherein the resetting of the remote cell phone ringer and flasher is through a reset.button on a device housing.

4. A remote missed call alert system for a cell phone comprising:
A housing;
A wireless interface within the housing and configured to be coupled wirelessly to at least one cell phone and configured to receive a signal at least when a call is received by one associated cell phone;
At least one visible light on the housing which is visible from at least 300 feet coupled to the wireless interface and configured to be illuminated in a designated pattern following the wireless interface indicating that a call has been received by one associated cell phone;
A manual reset on the housing configured to turn off each visible light whereby the system is reset for another call.

5. The remote missed call alert system for a cell phone according to claim 4 further including an audible alert on the housing coupled to the wireless interface and configured to indicate at least when a call is being received.

6. The remote missed call alert system for a cell phone according to claim 5 further including a battery power supply for the remote missed call alert.

7. The remote missed call alert system for a cell phone according to claim 6 wherein the wireless interface is a Bluetooth interface.

8. The remote missed call alert system for a cell phone according to claim 7 wherein the at least one visible light includes a strobe light.

9. The remote missed call alert system for a cell phone according to claim 7 wherein a series of lights in a light array are provided on the housing.

10. The remote missed call alert system for a cell phone according to claim 7 wherein visible lights of at least two distinct colors are provided.

11. The remote missed call alert system for a cell phone according to claim 10 wherein multiple cell phones are coupled to the system and wherein distinct colored lights are indicative of missed calls on distinct cell phones.

12. The remote missed call alert system for a cell phone according to claim 10 wherein distinct colored lights are indicative of incoming calls from distinct telephone numbers.

13. The remote missed call alert system for a cell phone according to claim 10 wherein distinct colored lights are indicative of distinct telephonic inputs received on the associated cell phone.

14. The remote missed call alert system for a cell phone according to claim 7 wherein the at least one visible light is configured to provide one lighting pattern for when an incoming call is being received and a second pattern when a call has been received as was missed.

15. A remote cell phone alert and missed call alert system configured to identify to the user when a call is being and has been received on a designated cell phone comprising:
A housing;
A wireless interface within the housing and configured to be coupled wirelessly to at least one cell phone and configured to receive a signal at least when a call is received by one associated cell phone;
At least one visible light on the housing which is visible from at least 300 feet coupled to the wireless interface and configured to be illuminated in a designated pattern following the wireless interface indicating that a call has been received by one associated cell phone;
an audible alert on the housing coupled to the wireless interface and configured to indicate at least when a call is being received.
A reset mechanism configured to turn off each visible light and the audible alert whereby the system is reset for another call.

16. The remote cell phone alert and missed call alert according to claim 15 wherein the wireless interface is a Bluetooth interface.

17. The remote cell phone alert and missed call alert according to claim 16 wherein the at least one visible light includes a strobe light.

18. The remote cell phone alert and missed call alert according to claim 16 wherein a series of lights in a light array are provided on the housing.

19. The remote cell phone alert and missed call alert according to claim 16 wherein visible lights of at least two distinct colors are provided.

20. The remote cell phone alert and missed call alert according to claim 19 wherein distinct colored lights are indicative of one of (i) missed calls on distinct cell phones, (ii) incoming calls from distinct telephone numbers, or (iii) distinct telephonic inputs received on the associated cell phone.
